(19) United States
(12) Patent Application Publication
(10) Pub. No.: US 2004/0184968 A1
(43) Pub. Date: Sep. 23, 2004

(54) Adaptor for dye terminator removal apparatus

(75) Inventors: Danielle Aschettino, Rodeo, CA (US); Brian A. Perry, Fremont, CA (US); Julie S. Hey, Fairfield, CA (US); Xuemei M. He, Walnut Creek, CA (US); Carolyn M. Seggerson, Alameda, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BIO-RAD LABORATORIES, INC., Hercules, CA

(21) Appl. No.: 10/394,998

(22) Filed: Mar. 21, 2003

(51) Int. Cl. B01L 11/00

(52) U.S. Cl. 422/103; 422/101

(57) ABSTRACT

A gel filtration plate designed to remove unincorporated dye terminator from a series of reaction mixtures in a nucleic acid sequencing operation is joined to an injection plate designed for insertion into a sequencing apparatus through an adaptor assembly that allows the two plates to be centrifuged together, thereby simultaneously purifying the reaction mixtures and collecting them in the receptacles that will be placed directly in the sequencer. The adaptor avoids the use of an intermediary collection plate and the need to transfer reaction mixtures from each well of the collection plate to each well of the injection plate.

### BACKGROUND OF THE INVENTION

1. Field of the Invention

This invention lies in the field of nucleic acid sequencing, and addresses in particular the types of apparatus used for preparing sequencing samples for analysis on automated instrumentation.

2. Description of the Prior Art

The determination of nucleotide sequences in genes and chromosomes is typically done by DNA sequencing involving the well-known polymerase chain reaction (PCR) with the use of dye terminators, followed by electrophoresis of the reaction product mixtures. The simultaneous electrophoresis of multiple product mixtures and the compilation of the sequencing data from the electropherograms is performed by automated analyzers that draw the mixtures from injection plates and place the mixtures in the capillaries where the electrophoretic separations occur, the various transfers occurring by electrokinetic means. In order for these separations to provide accurate and reliable sequencing data, the reaction product mixtures must be purified prior to the electrophoresis to remove unincorporated dye terminators and other impurities that are either left unreacted or generated during the reactions.

A common method of purifying the reaction product mixtures is gel filtration assisted either by a vacuum or by centrifugation. Gel filtration matrices and plates that contain arrays of filtration wells are commercially available from suppliers of sequencers. The typical filtration plate contains 96 wells in a standard array with the filtration material forming a bed in each well. Sequencing reaction samples are transferred by pipet to each well, and the filtration plate is fitted over a collection plate that has an array of wells corresponding to those of the filtration plate. Thus fitted, the two plates are placed on a centrifuge. After centrifuging, the collection plate is separated from the filtration plate, and the purified samples are transferred from the wells of the collection plate to the wells of an injection plate that is inserted into the sequencer for automated handling and electrophoresis. The injection plate is an array of receptacles that hold the samples in the sequencer until automated syringes in the sequencer draw the samples from the receptacles and transfer the drawn samples to capillaries in which the electrophoresis occurs.

The use of separate collection and injection plates and the need to transfer the samples from one of these plates to the other arises from the fact that the collection plate is designed for placement in a centrifuge with the filtration plate while the injection plate is designed for insertion into the sequencer, the centrifuge and the sequencer being separate pieces of equipment. Injection plates vary in construction depending on the particular sequencer for which they are designed. In general, however, the plates are simply supports for the receptacles whose closed ends are exposed at the bottom. Injection plates from certain manufacturers contain a skirt that surrounds the closed ends of the receptacles although the skirts are in some cases designed as a supporting feature rather than a protective feature. The skirt may thus extend sufficiently far down to cover the entire length of the receptacle, or it may extend only part way down leaving a portion of the length of each receptacle exposed. Other injection plates contain no skirt at all.

### SUMMARY OF THE INVENTION

This invention resides in an adaptor assembly that permits a multi-well gel filtration plate to be secured directly to a multi-well injection plate so that both can be placed on a centrifuge. The PCR reaction product mixtures can thus be purified and collected directly in the injection plate which can then be placed in the sequencer, without the need for an intervening collection plate and the transfer of purified samples from the collection plate to the injection plate. The adaptor assembly can match a gel filtration plate with any of a variety of injection plates of different configurations that are designed for sequencers from different suppliers.

The components of the adaptor assembly include a support base on which the injection plate rests and a bracket that holds together the gel filtration plate, the injection plate, and the support base. The bracket keeps the filtration plate and injection plate in alignment during centrifugation, avoiding cross-contamination between individual reaction mixtures. At the same time, the support base protects the lower ends of the sample receptacles in the injection plate from potential damage during centrifugation. These and other features, objects and advantages of the invention will be apparent from the description that follows.

### BRIEF DESCRIPTION OF THE DRAWINGS

FIG. 1 is an exploded view in perspective of an adaptor assembly in accordance with the present invention together with an injection plate for a nucleic acid sequencer.

FIG. 2 is a cross section view of the components shown in FIG. 1 in a fully assembled arrangement.

### DETAILED DESCRIPTION OF THE INVENTION AND PREFERRED EMBODIMENTS

While this invention is susceptible to a variety of configurations, arrangements and embodiments, the following discussion will focus on a specific example, the structural and functional aspects of which will serve to provide an understanding of the invention as a whole.

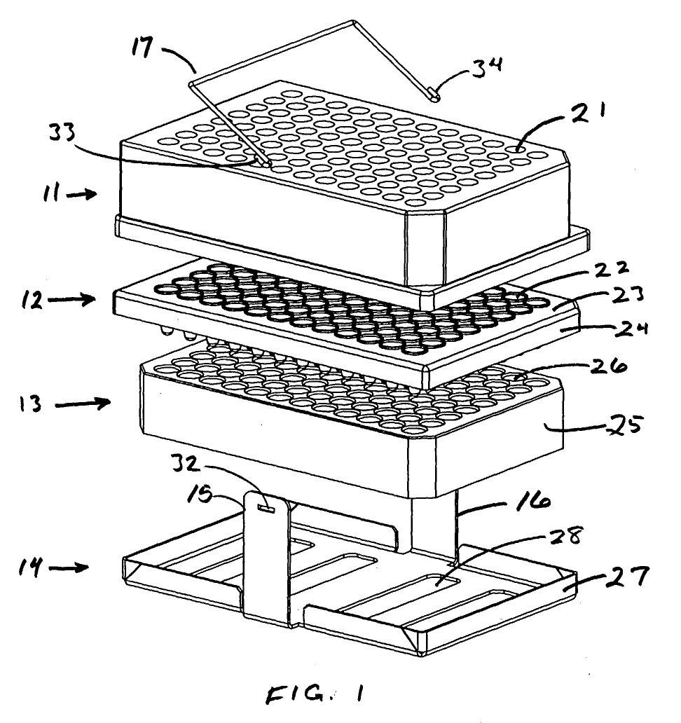

The exploded assembly of parts shown in FIG. 1 includes adaptor components to hold a gel filtration plate 11 and an injection plate 12 together and in proper alignment for simultaneous centrifugation. Each of these two plates has an array of 96 (8×12) wells as in the standard MICROTITER® (Dynex Technologies) plates, although the invention is likewise applicable to plates that have smaller or larger numbers of wells. Since the wells in the filtration and injection plates shown in FIG. 1 are of a standard spacing, the wells of one plate are readily aligned with those of the other. Nevertheless, since the filtration plate and the injection plate are not designed for use in the same instrument, these plates are not themselves equipped with features that facilitate and maintain their alignment. This function is served instead by the adaptor components of the present invention, which include the support base 13 and a bracket 14 which has upwardly extending tabs 15, 16. A handle 17 is included for attachment to the bracket 14 to allow the user to lift the entire assembly and transport the assembly from the centrifuge to the sequencer.

The filtration plate 11 is an array of flow-through wells 21, i.e., open at both the top and bottom but retaining a gel filtration matrix in each well to absorb impurities including unreacted dye terminators. The injection plate 12 is an array of receptacles 22 open at the top and closed at the bottom. The receptacles extend downward from a flat upper surface 23. Extending downward from the periphery of the surface 23 is a skirt 24, the receptacles being exposed at the bottom and unprotected other than by the skirt 24. The skirt 24 in the injection plate shown in the Figure is a partial skirt, extending over only part of the length of each receptacle, the ends of the receptacles extending below the skirt. Other injection plates may have a full skirt, i.e., one that extends the full length of the receptacles, or no skirt at all.

Each of the possible injection plate configurations (i.e., partial skirt, full skirt, or no skirt) is accommodated by the support base 13 which supports the injection plate and fully protects the receptacles. The support base 13 is hollow and contains a peripheral wall 25 that is of sufficient height to cover the protruding ends of the receptacles in the injection plate. In the example shown in the Figure, the support base 25 fits inside the skirt 24 of the injection plate. Apertures 26 in the support base are arranged in the same 8×12 array as the flow-through wells 21 in the filtration plate and the receptacles 22 in the injection plate, to receive the closed ends of the receptacles.

The bracket 14 has a flat bottom and side walls 27 on all four sides. The bottom has openings 28 to provide lightweight construction, and upwardly extending tabs 15, 16 on opposing side walls. The side walls are spaced widely enough to receive the entire support base 13 and to thereby secure the support base in a fixed position relative to the bracket. By engaging the receptacles in the injection plate 12, the support base 13 also stabilizes the position of the injection plate 12 relative to the bracket 14. The tabs 15, 16 extend upward to contact the side edges of the injection plate 12.

At the upper end of each tab is a small hole or eye (only one of which 32 is visible in the Figure). The two eyes receive hooks 33, 34 which are at the ends of the handle 17. The handle 17 is a U-shaped rod extending over the filtration plate to be grasped by the user's hand.

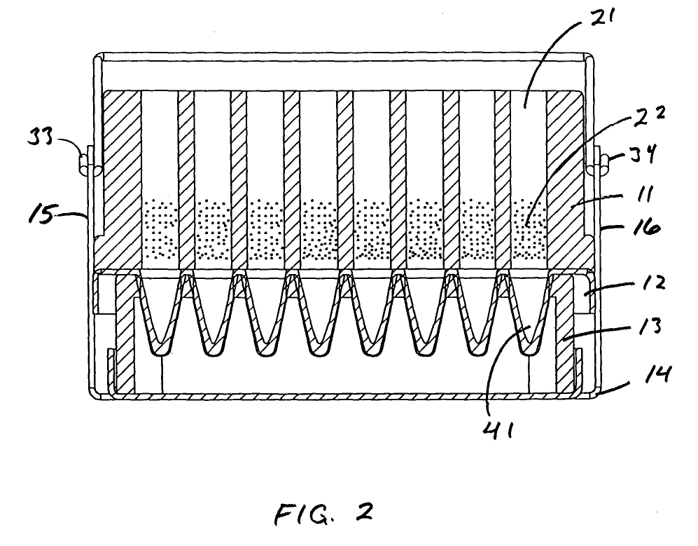

The components of the adaptor assembly are shown fully assembled in the cross section view of FIG. 2. The wells 21 of the filtration plate 11 are partially filled with gel matrix 22 which is supported in each well in a manner that allows the liquid reaction mixture to flow through the well to the receptacles 41 below.

The foregoing is offered primarily for purposes of illustration. Further alternatives as well as modifications and variations of the configurations, systems, materials, and procedural steps described above, which will be apparent to those skilled in the art upon reading this specification, are included within the scope of this invention.

What is claimed is:

1. An adaptor assembly for joining a gel filtration plate having a multitude of gel filtration wells arranged in a selected array and an injection plate having a multitude of receptacles arranged in an array identical to that of said gel filtration wells, said injection plate being designed for direct insertion in an automated nucleic acid sequencing apparatus, said adaptor assembly allowing said gel filtration and injection plates to be centrifuged together to simultaneously (i) purify product mixtures of a multitude of nucleic acid sequencing reactions by removal of unincorporated dye terminators from said product mixtures and (ii) collect said product mixtures thus purified in said injection plate, said adaptor assembly comprising:
a support base to support said injection plate, said support base having a peripheral wall of sufficient height to fully cover the external surfaces of said receptacles, and
a bracket shaped to secure said gel filtration plate, said injection plate, and said support base together while contacting at least two opposing peripheral edges of said gel filtration plate and said injection plate to maintain alignment between each well of said gel filtration plate and a corresponding receptacle of said injection plate.

2. An adaptor assembly in accordance with claim 1 in which said support base comprises a plurality of apertures arranged in an array identical to the array of said gel filtration wells and said receptacles, each of said apertures of sufficient size to receive one of said receptacles.

3. An adaptor assembly in accordance with claim 1 in which said bracket comprises a base plate and a pair of parallel tabs extending perpendicularly from opposing edges of said base plate.

4. An adaptor assembly in accordance with claim 3 in which said base plate is rectangular in shape and said bracket further comprises a raised rim on all four edges of said base plate such that said support base fits within said rim.

5. An adaptor assembly in accordance with claim 3 in which each of said tabs contains an opening and said adaptor assembly further comprises a U-shaped handle terminating at both ends in hooks that engage said openings.

6. A gel filtration and adaptor combination for receiving an injection plate which has a multitude of receptacles in a selected array and is designed for direct insertion in an automated nucleic acid sequencing apparatus, such that said combination together with said injection plate forms an assembly that can be placed on a centrifuge to simultaneously purify product mixtures from a multitude of nucleic acid sequencing reactions by removal of unincorporated dye terminators from said product mixtures and collect said product mixtures thus purified in said injection plate, said combination comprising:
a gel filtration plate having a multitude of gel filtration wells arranged in an array identical to that of said injection plate,
a support base shaped to permit said injection plate to rest thereon, said support base having a peripheral wall of sufficient height to fully cover the external surfaces of all receptacles of said injection plate, and
a bracket shaped to secure said gel filtration plate, said injection plate, and said support base together while contacting at least two opposing peripheral edges of said gel filtration plate and said injection plate to force each well of said gel filtration plate into alignment with a corresponding receptacle of said injection plate.

7. A gel filtration and adaptor combination in accordance with claim 6 in which said bracket comprises a base plate and a pair of parallel tabs extending perpendicularly from opposing edges of said base plate, each tab having an opening to receive a hook, and said gel filtration and adaptor combination further comprises a U-shaped handle terminating at both ends in hooks that engage said openings.

8. A gel filtration and adaptor combination in accordance with claim 6 in which said base plate is rectangular in shape and said bracket further comprises a raised rim on all four edges of said base plate such that said support base fits within said rim.
